(19) United States
(12) Patent Application Publication
(10) Pub. No.: US 2026/0026495 A1
(43) Pub. Date: Jan. 29, 2026

(54) STABLE PLASMIN COMPOSITIONS FOR ORGAN PRESERVATION AND RECONDITIONING

(71) Applicant: Grifols Worldwide Operations Limited, Clondalkin, Dublin (IE)

(72) Inventors: Valery NOVOKHATNY, Research Triangle Park, NC (US); David ROSS, Research Triangle Park, NC (US)

(21) Appl. No.: 18/994,538

(22) PCT Filed: Jul. 21, 2023
(86) PCT No.: PCT/EP2023/070276

§ 371 Date: Jan. 14, 2025

Related U.S. Application Data
(60) Provisional application No. 63/369,154, filed on Jul. 22, 2022.

(51) Int. Cl. A01N 1/126

(52) U.S. Cl. CPC A01N 1/126

(57) ABSTRACT

Disclosed herein are methods and compositions for preserving or reconditioning organs prior to transplant. The compositions of the present invention contain plasmin and/or functionally active mutants thereof formulated in a pharmaceutically acceptable organ preservation solution. The compositions are stable and non-toxic to the organ intended for transplant.

### FIELD OF THE INVENTION

The present invention details innovative compositions for the preservation and/or reconditioning of organs prior to transplantation.

### BACKGROUND

For many patients with end-stage diseases organ transplantation is the only viable treatment option. Naturally, a plentiful supply of quality donor organs is crucial to any successful transplantation program. Static cold storage (SCS) is one of the most frequently used methods for effective preservation and transportation of viable organs for transplant. SCS involves flushing the procured organ with preservation solution at 0-4° C., then immersing it into preservation solution at the same temperature until transplantation. The hypothermic environment is responsible for decreasing cellular metabolism, and the preservation solution reduces cellular metabolism and provides cytoprotection. The SCS preservation solutions are usually some variant of a buffer (eg. Histidine or phosphate) and antioxidant (eg., tryptophan-ketoglutarate, Glutathione-mannitol), characterized by varying concentrations of potassium and sodium ions.

Whilst the SCS method can suffer from a number of limitations including tissue damage induced by prolonged hypothermic preservation, difficulty in assessing donor organ function and viability, and reduced opportunity for organ repair its use remains highly prevalent in the field of transplantation.

The paucity of brain-dead organ donors renders the continuous, consistent supply of viable organs for transplantation challenging. A compromising resolution to this problem has been the reconditioning of organs donated after cardiac death (DCD) and has led to the use of extended criteria donor organs. As such, donor organ functional assessments and ex-vivo repair and reconditioning of organs prior to transplantation have become increasingly popular utilising machine perfusion/ex-vivo organ perfusion (EVOP).

EVOP involves organ perfusion with a controlled flow of perfusion solution. The method facilitates the maintenance of organ microvasculature tone, provision of oxygen and nutrients in support of tissue metabolism, and removal of toxic metabolic waste. Given that the cellular rate of respiration is proportional to the surrounding temperature, the temperature at which EVOP is performed can have an effect on organ preservation times and the responsivity of the organ to reconditioning. There are three main categories of EVOP: namely, normothermic machine perfusion at 35-38° C., subnormothermic machine perfusion at 20-34° C., and hypothermic machine perfusion at 0-8° C.

The criticality of the perfusate composition in reconditioning and maintaining stable organ function ex-vivo cannot be overstated. Over time, blood-based perfusates have largely been replaced by safer and more reproducible alternatives such as chemical solutions. The Steen Solution™ is one of the most widely used solutions for machine perfusion of lungs and supplementation of Steen Solution™/other organ perfusates with pharmacologically active materials is a novel area of research that holds much promise in the field of organ transplantation. One such example is US20190059362 to CSL Behring LLC, which discloses a lung perfusate solution containing alpha-1 antitrypsin.

The increasing use of marginal and DCD organs has seen the popularity of EVOP steadily increase as a means of assessing donor organ function. In addition to this, EVOP has also shown potential for enabling graft repair and reconditioning.

Notwithstanding the success of SCS and EVOP in providing viable organ transplants for patients, both practices can be rendered ineffective by the presence of thrombi in the organ for transplantation. Thrombosis of grafted organs presents a high risk in that the thrombi reduce perfusion of the transplant thereby reducing the efficacy of the storage and EVOP processes. Moreover, thrombosis in the donor organ is invariably associated graft dysfunction and poses a significant risk of embolic complications to the organ recipient. DCD organs are at particularly high risk of being rendered ineffective by thrombi and microthrombi. After the death of the DCD organ donor, the organs are harvested and perfused with cold preservation solution. Such steps prevent the formation of new thrombi but do not disrupt existing thrombi formed during the agonal period or immediately after death. Microthrombi can also be seen in organs from brain dead donors as a consequence of the metabolic events around the time of brain death.

Accordingly, the challenge to provide stable perfusate and/or storage solutions capable of removing of thrombi and other vascular occlusions formed in donor organs prior to transplant remains an unmet need.

### BRIEF DESCRIPTION OF THE INVENTION

In a first aspect, the invention relates to a stable composition for organ reconditioning comprising:
plasmin,
a lysine mimetic, and
a pharmaceutically acceptable organ preservation solution having a pH of about 6 to about 8,
wherein the molar ratio of plasmin:lysine mimetic is from about 1:1 to about 1:10,000.

In a second aspect, the invention relates to a method of preserving or reconditioning an organ prior to transplantation, the method comprising contacting the organ with the composition of the invention.

### FIGURES

FIG. 1 is a schematic of a number of plasmin variants and mutants within the scope of the present invention;

FIG. 2A) is a plot of plasmin solubility with varying concentrations of tranexamic acid; B) graph of plasmin solubility when formulated in tranexamic acid or L-arginine and diluted into organ preservation solutions.

FIG. 3 is a plot of plasmin activity in the presence of varying concentrations of tranexamic acid;

FIG. 4. A) is a plot of plasmin activity at 0° C. over a 24 hour period; B) graphs of plasmin activity with plasmin formulated in tranexamic acid and stored for 24 hours at various temperatures after dilution into organ preservation solutions; C) graphs of activity with plasmin formulated in tranexamic acid or ε-aminocaproic acid and stored for 1 month at 5° C. after dilution into organ preservation solutions.

FIG. 5 is a plot of the percentage of livers that survive after 24 hrs (POD1) in the control and plasmin treated groups; and

FIG. 6 provides plots of liver function as assessed by alkaline phosphatase levels and blood glucose levels after 24 hrs (POD1) in the control and plasmin treated groups.

### DETAILED DESCRIPTION OF THE INVENTION

The words “comprises/comprising” and the words “having/including” when used herein with reference to the present invention are used to specify the presence of stated features, integers, steps or components but do not preclude the presence or addition of one or more other features, integers, steps, components or groups thereof.

It should be appreciated by those skilled in the art that the specific embodiments disclosed herein should not be read in isolation, and that the present specification intends for the disclosed embodiments to be read in combination with one another as opposed to individually. As such, each embodiment may serve as a basis for modifying or limiting other embodiments disclosed herein.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “10 to 100” should be interpreted to include not only the explicitly recited values of 10 to 100, but also include individual value and sub-ranges within the indicated range. Thus, included in this numerical range are individual values such as 10, 11, 12, 13 . . . 97, 98, 99, 100 and sub-ranges such as from 10 to 40, from 25 to 40 and 50 to 60, etc. This same principle applies to ranges reciting only one numerical value, such as “at least 10”. Furthermore, such an interpretation should apply regardless of the breadth of the range or the characteristics being described.

### Composition of the Invention

In a first aspect, the present invention provides for a stable composition for organ reconditioning comprising:
plasmin,
a lysine mimetic, and
a pharmaceutically acceptable organ preservation solution having a pH of about 6 to about 8,
wherein the molar ratio of plasmin:lysine mimetic is from about 1:1 to about 1:10,000.

By “stable composition”, as used herein relates to a composition such that the plasmin component does not precipitate out of solution, neither immediately nor over time, thereby allowing for longer preservation of organs compared to prior art compositions. Any method known in the art can be used for determining whether a composition is stable or not, for example by any method for determining plasmin precipitation such as turbidity which is the process of measuring the loss of intensity of the light transmitted through a sample caused by the scattering effect of insoluble particles. The turbidity can be determined for example by measuring the absorbance at a wavelength of 405 nm. Other methods suitable for determining precipitation are for example refractometry, visual inspection (on a Black & White background light box), Micro Flow Imaging (MFI), Dynamic Light Scattering (DLS) and high speed centrifugation looking for visible pellet.

By “organ reconditioning” the present specification means preserving or improving the condition of organs intended for transplantation.

Native circulating human plasminogen, as set forth in SEQ ID NO: 1, is a single-chain protein containing 791 amino acid residues with 24 intra-chain disulfide bridges, 5 kringle domains, a serine protease domain, and a preactivation peptide (PAP). The locations of these domains with respect to SEQ ID NO: 1 are outlined in Table 1 infra.

TABLE 1

| Residues (per | | |
|---|---|---|
| SEQ ID No: 1) | Description | Length |
| 1-79 | PAP Domain | 79 |
| 84-162 | Kringle 1 | 79 |
| 165-243 | Kringle 2 | 79 |
| 275-333 | Kringle 3 | 78 |
| 358-435 | Kringle 4 | 78 |
| 462-541 | Kringle 5 | 80 |
| 562-789 | S1 Peptidase | 228 |

In the body, plasminogen is present as Glu-Plasminogen and Lys-Plasminogen depending on whether the N-terminal amino acid is either glutamic acid or lysine. Glu-Plasminogen is composed of the entire amino acid sequence designated by the gene sequence (excluding the precursor peptide). Lys-Plasminogen is the result of a cleavage of Glu-Plasminogen between predominantly Lys-77 and Lys-78. Glu-Plasminogen is the dominant form of plasminogen present in human plasma.

Once it has been secreted into plasma, plasminogen can be converted into plasmin by the action of tissue-type plasminogen activator (t-PA) or urokinase plasminogen activator (u-PA). t-Pa/u-PA cleave the Arg561-Val562 peptide bond in the plasminogen zymogen. The resulting plasmin molecule is a two-chain, disulfide-linked serine protease with trypsin-like specificity (cleaves after Lys and Arg).

The amino-terminal heavy chain of plasmin is composed of the five kringle domains, each containing approximately 80 amino acid residues. The kringle domains are responsible for the interactions of plasmin with other proteins, such as polymeric fibrin and the plasmin inhibitor α2-antiplasmin.

The C-terminal light chain of plasmin is a typical serine protease, homologous to trypsin and containing the classic serine protease catalytic triad: His603, Asp646, and Ser741.

“Plasmin”, as used herein relates to also known as fibrinolysin or lysofibrin, is a serine-type protease which results from the activation of the zymogen plasminogen. Activation is the result of a proteolytic cleavage between amino acids 561 and 562 (numbering relative to human Glu-plasminogen). Plasmin carries a heavy chain comprising 5 kringle domains and a light chain comprising the catalytic domain.

As used herein, the term “plasmin” is to be construed as meaning a therapeutically effective amount of a wild type (human) plasmin protein, a functional mutant thereof or a a functional fragment thereof, or combinations thereof.

“Functional mutant”, as used herein, relate to a sequence of plasmin having additions, substitutions, deletions or combinations thereof in its amino acid sequence and/or which has been chemically modified with respect to the sequence of plasmin and retains substantially equivalent catalytic ability. Preferably, the functional mutant of plasmin show the catalytic ability at least by 60%, preferably by 70%, advantageously by 80%, more preferably by 90%, more preferably by 95%, even more preferably by 97% and even more preferably by 98%, advantageously by 99%. In a particular embodiment, the functional mutant of plasmin have a sequence identity of at least 50%, at least 60%, at least 70%, at least 80%, at least 90%, at least 91%, at least 92%, at least 93%, at least 94%, at least 95%, at least 96%, at least 97%, at least 98% or at least 99% with the sequence shown in SEQ ID NO: 1.

“Functional fragment” as used herein relates to a part of the sequence of plasmin which contains the catalytic domain functional. Truncation of the plasmin molecule (outside and/or inside the plasmin catalytic domain) is possible as long as the catalytic domain remains functional, such truncation thus results in the formation of a “proteolytically active derivative” of plasmin. As such, one or more of the 5 kringle domains can be deleted wholly or partially. Truncated plasmins or functional fragments of plasmin lacking one or more kringle domains and/or lacking parts of one or more kringle domains therefore are envisaged by the current invention as examples of functionally fragments of plasmin or proteolytically active derivatives of plasmin. Examples of truncated variants of plasmin include, but are not limited to, “midiplasmin”, “miniplasmin”, “microplasmin”, and “delta-plasmin”.

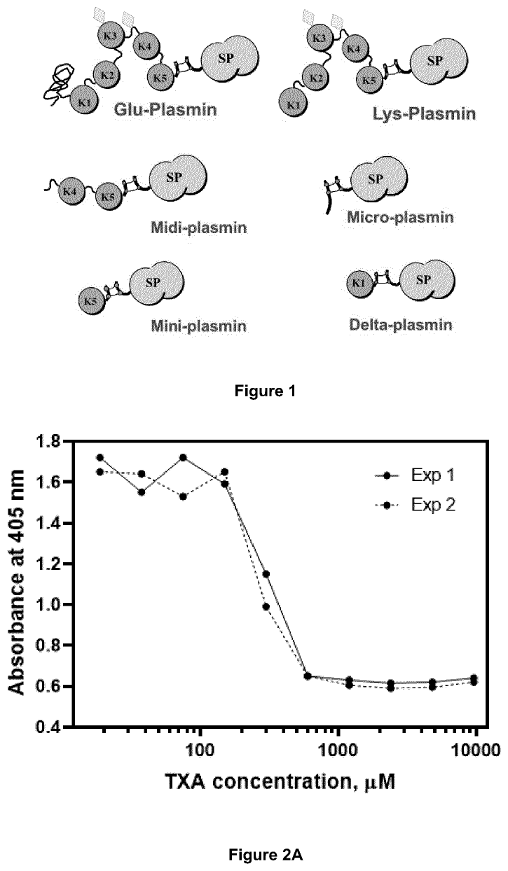

FIG. 1 discloses a schematic of a number of plasmin variants and mutants within the scope of the present invention. Mutants having various permutations of kringle domains 1-5 tethered to the serine protease component are within the scope of the invention. Minor variations in the amino acid sequence are irrelevant, provided the motifs outlined in FIG. 1 are maintained. The information outlined in SEQ ID NO: 1, Table 1 and FIG. 1 affords the skilled person with sufficient direction and clarity as to which plasmin mutants fall within the scope of the present invention.

According to the invention “plasmin” includes, but is not limited to:
(human) Glu-plasmin,
(human) Lys-plasmin,
midi-plasmin,
mini-plasmin,
micro-plasmin
delta-plasmin and combinations thereof.

“Midi-plasmin”, as used herein relates to plasmin lacking kringle domains 1 to 3 (e.g. Christensen et al., 1995, Biochem J 305, 97-102).

“Mini-plasmin”, as used herein relates to plasmin lacking kringle domains 1 to 4 (Christensen et al., 1979, Biochim Biophys Acta 567, 472-481; Powell & Castellino, 1980, J Biol Chem 255, 5329))

“Micro-plasmin”, as used herein relates to a low molecular weight form of plasmin which results from the specific autolytic cleavage of plasmin molecule in alkaline solution and that basically lacks all kringle domains. Suitable micro-plasmin are those disclosed in U.S. Pat. No. 4,774,087, or the commercialised plasmin mutant Ocriplasmin with CAS number 1048016-09-6.

“Delta-plasmin”, as used herein relates to a plasmin having an N-terminal domain homologous to a kringle domain of native human plasminogen that exhibit structural and functional characteristics similar to native kringle domains of plasminogen (U.S. Pat. No. 8,420,079). Delta plasmin lacks kringle domains 2 to 5.

In one embodiment, the plasmin is (human) Glu-plasmin. In some embodiments, the plasmin is (human) Lys-plasmin. In other embodiments, the plasmin is a mixture of Glu- and Lys-plasmin. As used herein, the term “pharmaceutically acceptable organ preservation solution” refers to a solution utilised in the perfusion and/or preservation of organs for transplant and it is typically characterised by the presence of colloidal components (eg.,human serum albumin, Dextran 40, mannitol, or other carbohydrate based materials) to maintain oncotic pressure close to that of human blood/serum/plasma, physiological ion concentrations to regulate osmolality, buffers to retain normal physiological pH, and in some cases an energy source (eg., carbohydrates such as glucose). The expression “pharmaceutically acceptable organ preservation solution” includes static cold storage solutions and perfusates utilised in normothermic machine perfusion, subnormothermic machine perfusion, and hypothermic machine perfusion.

Advantageously, the stable compositions for organ preservation of the present invention are effective in reducing thrombi and/or vascular occlusions in organs for transplant as they contain plasmin mixed with a pharmaceutically acceptable organ preservation solution. The composition can be used for preservation and/or ex-vivo perfusion of an organ, for example, for organ preservation during manipulation, treatment, storage and/or transport of an organ for transplantation in a recipient or reimplantation in a subject. The compositions of the present invention are particularly advantageous in that they are stable such that the plasmin component does not precipitate out of solution, neither immediately nor over time, thereby allowing for longer preservation of organs compared to prior art compositions. Naturally, compositions that facilitate longer preservation times prior to transplant will serve to increase the number of viable organs available for transplant.

In some embodiments, the pharmaceutically acceptable organ perfusate may have a pH of about 7.0-8.0, such as about 7.2-7.9, for example, about 7.4-7.85 at room temperature. All pH measurements denoted herein are to be construed as measured in water at 25° C.

In some embodiments, the pharmaceutically acceptable organ perfusate may have an osmolality of about 200-400 mOsm/kg, for example of about 250 to about 350 mOsm/Kg, such as of about 270 to about 330 mOsm/Kg. In certain embodiments, the pharmaceutically acceptable organ perfusate may have an osmolality range from about 275 to about 300 mOsm/kg. Solution osmolality can be readily determined utilising an analytical instrument called an osmometer, eg Precision Systems Osmette™, or Advanced Instruments OsmoTECH®.

The term “osmolality” is a measure of the total concentration of substances in solution, defined as the number of osmoles of solute per litre of solution, which indicates the potential variation of the osmotic pressure that will take place in the cells upon introducing the solution into the body. The osmolality may be calculated from the osmolality value, the latter being measured by an osmometer using methods known to those skilled in the art. Since the osmolality is dependent on the temperature, within the context of the present invention, the osmolality is calculated at 20° C.

“Lysine mimetic”, as used herein relates to an unnatural, natural, derivatives and/or analogues of amino acids comprising a C5-6 aliphatic or aromatic ring and at least two basic amine functionalities (i.e., at least one basic amine functionality in addition to the N-terminal amine). Mimetic as used herein means that the compounds bind to the lysine binding site of plasmin.

In some embodiments, the lysine mimetic may be chosen from the group consisting of tranexamic acid, ε-aminocaproic acid, L-lysine, L-arginine, L-ornithine, γ-aminobutyric acid, 5-aminovaleric acid, 7-aminoheptanoic acid, glycylglycine, triglycine, N-α-acetyl-L-arginine, betaine, sulfanilic acid, pharmaceutically acceptable salts thereof, and combinations thereof. In another preferred embodiment, the lysine mimetic is tranexamic acid. In another preferred embodiment, the lysine mimetic is ε-aminocaproic acid. In another preferred embodiment, the lysine mimetic is L-arginine. In another preferred embodiment, the lysine mimetic is L-lysine. In another preferred embodiment, the lysine mimetic is L-ornithine. In another preferred embodiment, the lysine mimetic is γ-aminobutyric acid. In another preferred embodiment, the lysine mimetic is 5-aminovaleric acid. In another preferred embodiment, the lysine mimetic is 7-aminoheptanoic acid. In another preferred embodiment, the lysine mimetic is glycylglycine. In another preferred embodiment, the lysine mimetic is triglycine. In another preferred embodiment, the lysine mimetic is N-α-acetyl-L-arginine. In another preferred embodiment, the lysine mimetic is betaine. In another preferred embodiment, the lysine mimetic is sulfanilic acid.

Preferably, in some embodiment, the composition comprises two lysine mimetic, more preferably tranexamic acid and ε-aminocaproic acid; tranexamic acid and L-lysine; tranexamic acid and L-arginine; tranexamic acid and L-ornithine; tranexamic acid and γ-aminobutyric acid; tranexamic acid and 5-aminovaleric acid; tranexamic acid and 7-aminoheptanoic acid; tranexamic acid and glycylglycine; tranexamic acid and triglycine; ε-aminocaproic acid and L-lysine; ε-aminocaproic acid and L-arginine; ε-aminocaproic acid and L-ornithine; ε-aminocaproic acid and γ-aminobutyric acid; ε-aminocaproic acid and 5-aminovaleric acid; ε-aminocaproic acid and 7-aminoheptanoic acid; ε-aminocaproic acid and glycylglycine; ε-aminocaproic acid and triglycine; L-lysine and L-arginine; L-lysine and L-ornithine; L-lysine and γ-aminobutyric acid; L-lysine and 5-aminovaleric acid; L-lysine and 7-aminoheptanoic acid; L-lysine and glycylglycine; L-lysine and triglycine; L-arginine and L-ornithine; L-arginine and γ-aminobutyric acid; L-arginine and 5-aminovaleric acid; L-arginine and 7-aminoheptanoic acid; L-arginine and glycylglycine; L-arginine and triglycine; L-ornithine and γ-aminobutyric acid; L-ornithine and 5-aminovaleric acid; L-ornithine and 7-aminoheptanoic acid; L-ornithine and glycylglycine; L-ornithine and triglycine; γ-aminobutyric acid and 5-aminovaleric acid; γ-aminobutyric acid and 7-aminoheptanoic acid; γ-aminobutyric acid and glycylglycine; γ-aminobutyric acid and triglycine; 5-aminovaleric acid and 7-aminoheptanoic acid; 5-aminovaleric acid and glycylglycine; 5-aminovaleric acid and triglycine; 7-aminoheptanoic acid and glycylglycine; 7-aminoheptanoic acid and triglycine; or glycylglycine and triglycine.

In a more preferred embodiment, the composition comprises tranexamic acid and ε-aminocaproic acid.

In another preferred embodiment, the composition comprises three lysine mimetic. In a more preferred embodiment, the composition of the invention comprises ε-aminocaproic acid, tranexamic acid and L-arginine.

For example, the lysine mimetic may be chosen from the group consisting of tranexamic acid, ε-aminocaproic acid, L-arginine, pharmaceutically acceptable salts thereof, and combinations thereof. In another preferred embodiment, the lysine mimetic is tranexamic acid. In another preferred embodiment, the lysine mimetic is ε-aminocaproic acid. In another preferred embodiment, the lysine mimetic is L-arginine.

In certain embodiments, the lysine mimetic is a compound of the general formula (i) or a pharmaceutically acceptable salt thereof:

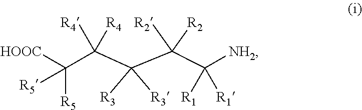

wherein
each of R₁-R₅, and each R_{1′}-R_{5′} is the same or different and is independently selected from the group consisting of hydrogen, halogen, C₁-C₅ alkyl, C₁-C₅ haloalkyl, OH, C₁-C₅ alkoxy, C₁-C₅ haloalkoxy, SH, C₁-C₅ alkylthio, C₁-C₅ haloalkylthio, C₁-C₆ alkylsulfinyl, C₁-C₆ haloalkylsulfinyl, C₁-C₅ alkylsulfonyl, C₁-C₅ haloalkylsulfonyl, C₁-C₆ alkylsulfonamido, C₁-C₆ haloalkylsulfonamido, C₁-C₆ bis(alkyl) sulfonamido, C₁-C₅ bis(haloalkyl)sulfonamido, NH₂, NH(C₁-C₆ alkyl), N(C₁-C₆ alkyl)₂, NH(C₁-C₅ haloalkyl), N(C₁-C₅ haloalkyl)₂, N(C₁-C₅ alkyl)(C₁-C₅ haloalkyl), C(O)NH(C₁-C₆ alkyl), C(O)N(C₁-C₆ alkyl)₂, C(O)NH(C₁-C₆ haloalkyl), C(O)N(C₁-C₆ haloalkyl)₂, C(O)N(C₁-C₆ alkyl)(C₁-C₆ haloalkyl), C(O)H, C(O)C₁-C₆ alkyl, C(O)C₁-C₆ haloalkyl, C(O)O(C₁-C₆ alkyl), C(O)O(C₁-C₆ haloalkyl), OC(O)C₁-C₆ haloalkyl, OC(O)C₁-C₆ alkyl, SF5, SCN, cyano, and nitro.

In other embodiments, the lysine mimetic may be a compound of the general formula (ii) or a pharmaceutically acceptable salt thereof:

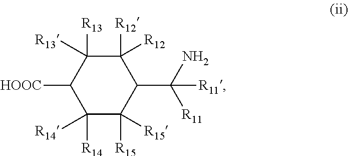

wherein
each of R₁₁-R₁₅, and each R_{11′}-R_{15′} is the same or different and is independently selected from the group consisting of hydrogen, halogen, C₁-C₅ alkyl, C₁-C₅ haloalkyl, OH, C₁-C₅ alkoxy, C₁-C₅ haloalkoxy, SH, C₁-C₅ alkylthio, C₁-C₅ haloalkylthio, C₁-C₆ alkylsulfinyl, C₁-C₆ haloalkylsulfinyl, C₁-C₅ alkylsulfonyl, C₁-C₅ haloalkylsulfonyl, C₁-C₆ alkylsulfonamido, C₁-C₆ haloalkylsulfonamido, C₁-C₆ bis(alkyl)sulfonamido, C₁-C₅ bis(haloalkyl)sulfonamido, NH₂, NH(C₁-C₆ alkyl), N(C₁-C₆ alkyl)₂, NH(C₁-C₅ haloalkyl), N(C₁-C₅ haloalkyl)₂, N(C₁-C₅ alkyl) (C₁-C₅ haloalkyl), C(O)NH(C₁-C₆ alkyl), C(O)N(C₁-C₆ alkyl)₂, C(O)NH(C₁-C₆ haloalkyl), C(O)N(C₁-C₆ haloalkyl)₂, C(O)N(C₁-C₆ alkyl)(C₁-C₆ haloalkyl), C(O)H, C(O)C₁-C₆ alkyl, C(O)C₁-C₆ haloalkyl, C(O)O(C₁-C₆ alkyl), C(O)O(C₁-C₆ haloalkyl), OC(O)C₁-C₆ haloalkyl, OC(O)C₁-C₆ alkyl, SF5, SCN, cyano, and nitro.

In some embodiments of the invention, plasmin may be present in the composition of the present invention at a concentration of about 0.01 mg/mL to about 50 mg/mL. For example, plasmin may be present in the composition of the present invention at a concentration of about 0.01 mg/mL to about 30 mg/mL. In some embodiments, plasmin may be present in the composition of the present invention at a concentration of about 0.01 mg/mL to about 20 mg/mL. In other embodiments, plasmin may be present in the composition of the present invention at a concentration of about 0.05 mg/mL to about 20 mg/mL. In yet a further embodiment, plasmin may be present in the composition of the present invention at a concentration of about 0.05 mg/mL to about 10 mg/mL. In other embodiments, plasmin may be present in the composition of the present invention at a concentration of about 0.05 mg/mL to about 5 mg/mL. In particular embodiments, plasmin may be present in the composition of the present invention at a concentration of about 0.05 mg/mL to about 2.5 mg/mL. In further embodiments, plasmin may be present in the composition of the present invention at a concentration of about 0.05 mg/ml to about 1 mg/mL. In a preferred embodiment, the plasmin is present in the composition of the invention at a concentration of 0.1 mg/mL.

The composition of any preceding claim, wherein the lysine mimetic is present in a concentration of about 0.1 μM to about 0.6 M. In some embodiments, the lysine mimetic is present in a concentration of about 10 μM to about 0.4 M. In other embodiments, the lysine mimetic is present in a concentration of about 100 μM to about 0.2 M. In further embodiments, the lysine mimetic is present in a concentration of about 1 mM to about 0.1 M. For example, the lysine mimetic may be present in a concentration of about 10 μM to about 1 mM. In particular embodiments, the lysine mimetic may be present in a concentration of about 50 μM to about 100 μM. In another preferred embodiment, the lysine mimetic is present in a concentration of 10 μM. In another preferred embodiment, the lysine mimetic is present in a concentration of 25 μM. In another preferred embodiment, the lysine mimetic is present in a concentration of 50 μM. In another preferred embodiment, the lysine mimetic is present in a concentration of 0.1 mM. In another preferred embodiment, the lysine mimetic is present in a concentration of 0.75 mM. In another preferred embodiment, the lysine mimetic is present in a concentration of 1.5 mM. In another preferred embodiment, the lysine mimetic is present in a concentration of 3 mM. In another preferred embodiment, the lysine mimetic is present in a concentration of 6 mM.

In some embodiments, the lysine mimetic may be chosen from the group consisting of tranexamic acid, ε-aminocaproic acid, L-arginine, pharmaceutically acceptable salts thereof, and combinations thereof and the lysine mimetic may be present in a concentration of about 10 μM to about 100 mM. In other embodiments, the lysine mimetic may be chosen from the group consisting of tranexamic acid, ε-aminocaproic acid, L-arginine, pharmaceutically acceptable salts thereof, and combinations thereof and the lysine mimetic may be present in a concentration of about 50 μM to about 1 mM. In another preferred embodiment, the lysine mimetic is tranexamic acid and is present in a concentration of 10 μM. In another preferred embodiment, the lysine mimetic is tranexamic acid and is present in a concentration of 25 μM. In another preferred embodiment, the lysine mimetic is tranexamic acid and is present in a concentration of 50 μM. In another preferred embodiment, the lysine mimetic is tranexamic acid and is present in a concentration of 0.1 mM. In another preferred embodiment, the lysine mimetic is L-arginine and is present in a concentration of 0.75 mM. In another preferred embodiment, the lysine mimetic is L-arginine and is present in a concentration of 1.5 mM. In another preferred embodiment, the lysine mimetic is L-arginine and is present in a concentration of 3 mM. In another preferred embodiment, the lysine mimetic is L-arginine and is present in a concentration of 6 mM. In another preferred embodiment, the lysine mimetic is ε-aminocaproic acid and is present in a concentration of 0.1 mM.

In a preferred embodiment, the concentration of tranexamic acid is between 0.001 mM to 100 mM. In another preferred embodiment, the composition comprises a concentration of tranexamic acid above 5 μM.

In some embodiments of the composition of the present invention, the molar ratio of plasmin:lysine mimetic may be from about 1:1 to about 1:1,000. For example, the molar ratio of plasmin:lysine mimetic may be from about 1:1 to about 1:500. In other embodiments, the molar ratio of plasmin:lysine mimetic may be from about 1:1 to about 1:100. In certain embodiments, the molar ratio of plasmin:lysine mimetic may be from about 1:1 to about 1:50. In particular embodiments, the molar ratio of plasmin:lysine mimetic may be from about 1:10 to about 1:10,000. In further embodiments, the molar ratio of plasmin:lysine mimetic may be from about 1:10 to about 1:1,000. For example, the molar ratio of plasmin:lysine mimetic may be from about 1:10 to about 1:100. In yet further embodiments, the molar ratio of plasmin:lysine mimetic may be from about 1:10 to about 1:50. In particular embodiments, the molar ratio of plasmin:lysine mimetic may be from about 1:30 to about 1:10,000. In further embodiments, the molar ratio of plasmin:lysine mimetic may be from about 1:30 to about 1:1,000. For example, the molar ratio of plasmin:lysine mimetic may be from about 1:30 to about 1:100. In yet further embodiments, the molar ratio of plasmin:lysine mimetic may be from about 1:30 to about 1:50. In other embodiments, the molar ratio of plasmin:lysine mimetic may be from about 1:50 to about 1:10,000. In further embodiments, the molar ratio of plasmin:lysine mimetic may be from about 1:50 to about 1:1,000. For example, the molar ratio of plasmin:lysine mimetic may be from about 1:50 to about 1:100. In a preferred embodiment, the molar ratio of plasmin:lysine mimetic is 1:50. In another preferred embodiment the molar ratio of plasmin:lysine mimetic is 1:10.

In some embodiments, the lysine mimetic may be chosen from the group consisting of tranexamic acid, ε-aminocaproic acid, L-arginine, pharmaceutically acceptable salts thereof, and combinations thereof and the molar ratio of plasmin:lysine mimetic may be from about 1:1 to about 1:1,000. For example, the molar ratio of plasmin:lysine mimetic may be from about 1:1 to about 1:500. In other embodiments, the molar ratio of plasmin:lysine mimetic may be from about 1:1 to about 1:100. In certain embodiments, the molar ratio of plasmin:lysine mimetic may be from about 1:1 to about 1:50.

In other embodiments, the lysine mimetic may be chosen from the group consisting of tranexamic acid, ε-aminocaproic acid, L-arginine, pharmaceutically acceptable salts thereof, and combinations thereof and the molar ratio of plasmin:lysine mimetic may be from about 1:10 to about 1:10,000. In further embodiments, the molar ratio of plasmin:lysine mimetic may be from about 1:10 to about 1:1,000. For example, the molar ratio of plasmin:lysine mimetic may be from about 1:10 to about 1:100. In yet further embodiments, the molar ratio of plasmin:lysine mimetic may be from about 1:10 to about 1:50.

In certain embodiments, the lysine mimetic may be chosen from the group consisting of tranexamic acid, ε-aminocaproic acid, L-arginine, pharmaceutically acceptable salts thereof, and combinations thereof and the molar ratio of plasmin:lysine mimetic may be from about 1:30 to about 1:10,000. In further embodiments, the molar ratio of plasmin:lysine mimetic may be from about 1:30 to about 1:1,000. For example, the molar ratio of plasmin:lysine mimetic may be from about 1:30 to about 1:100. In yet further embodiments, the molar ratio of plasmin:lysine mimetic may be from about 1:30 to about 1:50.

In further embodiments, the lysine mimetic may be chosen from the group consisting of tranexamic acid, ε-aminocaproic acid, L-arginine, pharmaceutically acceptable salts thereof, and combinations thereof and the molar ratio of plasmin:lysine mimetic may be from about 1:30 to about 1:1,000. In further embodiments, the molar ratio of plasmin:lysine mimetic may be from about 1:30 to about 1:100. For example, the molar ratio of plasmin:lysine mimetic may be from about 1:30 to about 1:70. In other embodiments, the molar ratio of plasmin:lysine mimetic may be about 1:50. In other embodiments, the molar ratio of plasmin:lysine mimetic may be about 1:10. In some embodiments, the pharmaceutically acceptable organ perfusate may have an osmolality of about 200-400 mOsm/kg, for example of about 250 to about 350 mOsm/Kg, such as of about 270 to about 330 mOsm/Kg. In certain embodiments, the pharmaceutically acceptable organ perfusate may have an osmolality range from about 275 to about 300 mOsm/kg. Solution osmolality can be readily determined utilising an analytical instrument called an osmometer, eg Precision Systems Osmette™, or Advanced Instruments OsmoTECH®.

In some embodiments of the composition of the present invention, the pharmaceutically acceptable organ preservation solution may be the STEEN™ solution or a derivative thereof. The composition of STEEN™ solution is described for example in U.S. Pat. No. 7,255,983B2.

In other embodiments of the composition of the present invention, the pharmaceutically acceptable organ preservation solution may be a cold storage solution selected from the group consisting of the Euro Collins (EC) solution (Annual Report Eurotransplant International Foundation. Leiden, The Netherlands: Eurotransplant International Foundation, 1976), the University of Wisconsin (UW) solution [ViaSpan®] also known as Beizer (Belzer F O and Southard J H. Transplantation, 1988; 45:673, U.S. Pat. No. 4,879,283), the HTK/Custodiol® solution also known as the HTK (histidine-tryptophan-ketoglutarate) solution or Bretschneider solution (Bretschneider H J. Thorac Cardiovasc Surg, 1980; 28:295), the Celsior® solution (CEL) Menasche P et al. Eur J Cardiothorac Surg, 1994; 8:207), the Institut Georges López solution (IGL-1) (Ben Abdennebi H et al. Transpl Int 2002; 15:348), the Marshall's solution (HOC or hyperosmolar citrate) (Southard J H, Belzer F O. Annu Rev Med 1995; 46:235) the Perfadex® solution (Müller C et al. Transplantation, 1999; 68:1139-43), the IGL-1° solution, the EP-TU solution (Okada et al Surg Today (2012) 42:152-156), the ET-Kyoto solution (Chen F et al. Yonsei Med J, 2004; 45:1107-1114), the Polysol solution (Wei L et al. World J Gastroenterol, 2007; 13:3684-3691), sucrose phosphate buffer (Lam F T et al. Transplantation, 1989; 47:767), the St. Thomas Hospital solutions 1 and 2 (STH-1, STH-2) (Michel P et al. J Heart Lung Transplant, 2002; 21:1030-9), the Lyon preservation solution (LYPS) (Michel P et al. J Heart Lung Transplant, 2000; 19:1089-1097), the Somah solution (Ferng et al Journal of Cardiothoracic Surgery (2017) 12:7), the Stanford solution (STF) (Michel P et al. J Heart Lung Transplant, 2002; 21:1030-9) the KPS-1 solution, and combinations thereof. In one embodiment, the pharmaceutically acceptable organ preservation solution may be a cold storage solution selected from the group consisting of the University of Wisconsin (UW) solution, the HTK/Custodiol® solution, the Celsior® solution, and combinations thereof. For example, the pharmaceutically acceptable organ preservation solution may be the HTK/Custodiol® solution. In another preferred embodiment, the organ preservation solution is HTK solution. In another preferred embodiment, the organ preservation solution is KPS-1 Solution. In another preferred embodiment, the organ preservation solution is Beizer (UW) solution.

The composition of the solutions disclosed herein are widely known in the art. Okada et al Surg Today (2012) 42:152-156 discloses the composition of EP-TU and EC solutions. Guibert et al Transfus Med Hemother 2011; 38:125-142 discloses the composition of EC, UW (Viaspan), Celsior, Custodial and IGL-1. Muhlbacher et al Transplantation Proceedings, 31, 2069-2070 (1999) discloses the compositions of EC, UW, HTK and Celsior. Ferng et al Journal of Cardiothoracic Surgery (2017) 12:7 discloses the composition of Celsior, Perfadex and Somah solutions. Document Chen et al Yonsei Med J Vol 45, No 6 (2004) p1107 discloses the ET-Kyoto, EC and UW solution. Documento Jing et al Acta Pharmacologica Sinica (2018) 39:845-857 discloses the composition of EC, UW, HTK/Custodial, Celsior, Perfadex, EP-TU and ET-Kyoto solutions.

In some embodiments of the composition of the present invention, the pharmaceutically acceptable organ preservation solution may comprise at least one additive selected from the group consisting of a physiologically acceptable salt, a buffer, a colloidal carbohydrate, an antioxidant, and combinations thereof. The solution may additionally comprise a source of energy and nutrients for the organ. Suitable materials include, without limitation, glucose, amino acids, vitamins, lipids, and combinations thereof.

In some embodiments, the physiologically acceptable salt may comprise an ion selected from the group consisting of a sodium ion, potassium ion, calcium ion, magnesium ion, hydrogen carbonate ion, bicarbonate ion, chloride ion, and combinations thereof. For example, the physiologically acceptable salt may be selected from the group consisting of sodium chloride, potassium chloride, calcium chloride, magnesium chloride, sodium dihydrogen phosphate, sodium bicarbonate, sodium hydroxide, and combinations thereof.

In certain embodiments, the buffer may be an amino acid selected from the group consisting of histidine, tryptophan, N-acetylhistidine, glycine, alanine, arginine, aspartate, glutamic acid, and combinations thereof. For example, the amino acid may be a combination of histidine, and tryptophan. In particular embodiments, the buffer may comprise a phosphate-based buffer in combination with one of the above listed amino acids. In another preferred embodiment, the buffer comprises a phosphate-based buffer.

In other embodiments, the colloidal carbohydrate may be selected from the group consisting of a dextran compound, mannitol, and combinations thereof. For example, the dextran may be Dextran 40.

In yet further embodiments, the antioxidant may be selected from the group consisting of α-ketoglutarate, glutathione, and combinations thereof.

In certain embodiments of the composition of the present invention, the pharmaceutically acceptable organ preservation solution may comprise an additive selected from the group consisting of albumin, a dextran compound, a physiologically acceptable salt, and combinations thereof. In a preferred embodiment the additive is heparin. In another preferred embodiment, the additive is zosyn. In another preferred embodiment the additive is dexamethasone. In another preferred embodiment the additive is bicarbonate. In another preferred embodiment the additive is calcium gluconate.

In some embodiments, the concentration of albumin may be from about 1 mg/ml to about 100 mg/mL, from about 5 mg/mL to about 85 mg/mL, from about 10 mg/mL to about 70 mg/mL, from about 20 mg/mL to about 60 mg/mL. In other embodiments, the concentration of albumin may be from about 5 mg/mL to about 30 mg/mL. In further embodiments, the concentration of albumin may be from about 60 mg/mL to about 90 mg/mL. In another embodiment, the concentration of albumin is from about 50 mg/mL to about 100 mg/mL, from about 55 mg/mL to about 85 mg/mL, from about 60 mg/mL to about 80 mg/mL, from about 65 mg/mL to about 85 mg/mL, from about 70 mg/ml to about 80 mg/mL, about 50 mg/mL, about 60 mg/mL, about 65 mg/mL, about 70 mg/mL, about 75 mg/mL, about 80 mg/mL, about 85 mg/mL, about 90 mg/mL, or about 100 mg/mL.

In certain embodiments, the dextran compound comprises a dextran having a molecular weight of from about 1 kDa to about 250 kDa, of from about 20 kDa to about 150 kDa, of from about 50 kDa to about 100 kDa, of about 1 kDa, of about 5 kDa, of about 10 kDa, of about 20 kDa, of about 30 kDa, of about 40 kDa, of about 50 kDa, of about 60 kDa, of about 70 kDa, of about 80 kDa, of about 90 kDa, of about 100 kDa, of about 150 kDa, of about 200 kDa, or of about 250 kDa. For example, the dextran compound may comprise a dextran having a molecular weight of about 40 kDa.

In certain embodiments, the concentration of the dextran compound may be from about 1 mg/mL to about 55 mg/mL, from about 2 mg/mL to about 25 mg/mL, from about 2 mg/mL to about 20 mg/mL, from about 2 mg/mL to about 10 mg/mL, about 2 mg/mL, about 5 mg/mL, about 10 mg/mL, about 20 mg/mL, or about 25 mg/mL. In some embodiments, the concentration of dextran compound may be about 5 mg/mL.

In some embodiments, the physiologically acceptable salt may comprise an ion selected from the group consisting of a sodium ion, potassium ion, calcium ion, magnesium ion, hydrogen carbonate ion, bicarbonate ion, chloride ion, and combinations thereof. For example, the physiologically acceptable salt may be selected from the group consisting of sodium chloride, potassium chloride, calcium chloride, magnesium chloride, sodium dihydrogen phosphate, sodium bicarbonate, sodium s hydroxide, and combinations thereof.

In particularly preferred embodiments, the physiologically acceptable salt is present in a concentration range deemed to be normal in human blood, human serum, or human plasma. For example, the physiologically acceptable salt may comprise an ion selected from the group consisting of a sodium ion at a concentration of from about 135 mM to about 150 mM, potassium ion at a concentration of from about 3 mM to about 5 mM, chloride ion at a concentration of from about 95 mM to 110 mM, hydrogen carbonate ion at a concentration of from 20 mM to 30 mM, bicarbonate ion at a concentration of from 20 mM to 30 mM, calcium ion at a concentration of from 2 to 3 mM, phosphate ion at a concentration of from 1 mM to 1.5 mM, and combinations thereof.

In certain embodiments, the physiologically acceptable salt is selected from the group consisting of sodium chloride at a concentration of from 75 mM to 150 mM, potassium chloride at a concentration of from 0.4 mM to 5 mM, calcium chloride at a concentration of from 1 mM to 2 mM, magnesium sulfate at a concentration of from 1 mM to 2 mM, sodium bicarbonate at a concentration of from 10 mM to 20 mM, and combinations thereof.

It should be appreciated by those skilled in the art that the specific embodiments disclosed within paragraphs [0013]-[0045] should not be read in isolation, and that the present specification intends for these embodiments to be disclosed in combination with other embodiments as opposed to being disclosed individually.

### Methods of the Present Invention

In a second aspect, the present invention provides for a method of preserving or reconditioning an organ prior to transplantation, the method comprising contacting the organ with the composition of the present invention.

“Organ” as used herein relates to any a part of an organism which is typically self-contained and has a specific vital function. In a preferred embodiment, the organ is selected from the group consisting of kidney, liver, heart, lungs, pancreas and intestines. In a more preferred embodiment, the organ is liver.

In one embodiment, the organ is perfused with the composition of the present invention (as part of an ex-vivo organ preservation or reconditioning process).

In some embodiments, the organ is isolated. In some embodiment, the composition is contacted with the organ by washing, immersion, perfusion or a combination thereof. In yet another embodiment, the composition is contacted with the organ by in vivo perfusion in the donor. In another embodiment, the composition is contacted with the organ by means of perfusion when said organ is isolated from the donor. In yet another embodiment, the organ comes from a dead donor.

In a further embodiment, the organ is contacted with the composition of the present invention at lower temperature (as part of a static cold storage process or a subnormothermic perfusion process). For example, the organ may be contacted with or perfused with the composition of the present invention at a temperature selected from the group consisting of about 20-37° C., and about 0-10° C. In one embodiment, the organ may be contacted with or perfused with the composition of the present invention at a temperature of about 0-10° C. In certain embodiments, the organ may be contacted with the composition of the present invention at a temperature of about 0° C. Advantageously, plasmin demonstrates proteolytic activity at temperatures of about 0-10° C. and even at 0° C. in the stable formulations of the present invention.

It should be appreciated by those skilled in the art that the specific embodiments previously disclosed should not be read in isolation, and that the present specification intends for these embodiments to be disclosed in combination with other embodiments as opposed to being disclosed individually. For example, each of the embodiments disclosed in the description is to be read as being explicitly combined with each of the embodiments disclosed in other part of the description], or any permutation of 2 or more of the embodiments disclosed therein.

All the terms and embodiment previously disclosed in relation to the composition of the invention are equally applicable to the method of the invention.

### Detailed Examples of the Invention

It should be readily apparent to one of ordinary skill in the art that the examples disclosed herein below represent generalised examples only, and that other arrangements and methods capable of reproducing the invention are possible and are embraced by the present invention.

### Example 1: In-Vitro Solubility and Activity Studies

Plasmin is stable in acidic solution, but once added to neutral solutions the stabilising effect of the acidic pH diminishes and plasmin begins to precipitate out of solution. A solution of full-length plasmin (11 mg/ml, pH 3.4) with varying concentrations of tranexamic acid (TXA) was added to human plasma at 1:10 ratio, at room temperature, and the resulting turbidity was measured by absorbance at 405 nm in a microtitre plate.

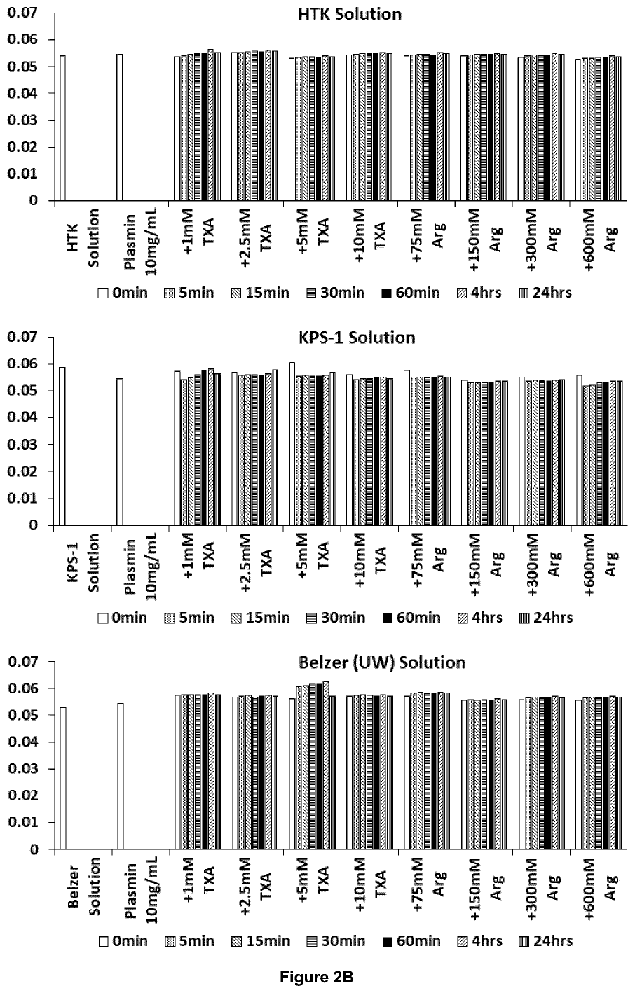

From FIG. 2A it is evident that turbidity/plasmin precipitation decreases with increasing TXA concentration. In particular, once the plasmin is added to test plasma at a fully diluted concentration of 1 mg/mL, TXA concentrations of 0.5 mM and above significantly reduce the level of plasmin precipitation.

From FIG. 2B it can be concluded that plasmin formulated with tranexamic acid or L-arginine is soluble in a variety of commonly utilized organ preservation and reconditioning solutions. Plasmin formulated at 10 mg/mL with tranexamic acid (1 mM, 2.5 mM, 5 mM, or 10 mM TXA) or L-arginine (75 mM, 150 mM, 300 mM, or 600 mM Arg) were diluted 1:100 directly into HTK, KPS-1, or Belzer University of Wisconsin (UW) organ preservation solutions with no other additives. For each graph, the turbidity measurement at 405 nm is shown for the individual organ preservation solution with no additives, soluble plasmin at 10 mg/mL with no excipients, and plasmin plus the indicated excipient diluted 1:100 into organ preservation solution. Each formulation diluted in preservation and reconditioning solution was tested for turbidity after the indicated incubation time. Diluted plasmin formulated with the indicated excipient remained soluble in all cases and at all time points, with no increase in turbidity for at least 24 hours when stored at 4° C.

Full-length plasmin, was prepared according to the procedures/methodology known by those skilled in the art and detailed in section 18.3 of Novokhatny, V. et al., Acid Stabilised Plasmin as a Novel Direct-Acting Thrombolytic, Ch 18, pg 259-271, Production of Plasma Proteins for Therapeutic Use, Eds. J. Bertolini, et al., Wiley, 2013 [Print ISBN: 9780470924310|Online ISBN: 9781118356807], the contents of which are incorporated herein by reference. By “full-length plasmin” the present specification means a mixture of Lys-plasmin and Glu-plasmin and excludes the mutants outlined in FIG. 1. The truncated plasmin mutants outlined in FIG. 1 can be prepared recombinantly using manufacturing processes within the common general knowledge of the skilled person and purified in accordance with procedures disclosed in Novokhatny et al. (supra).

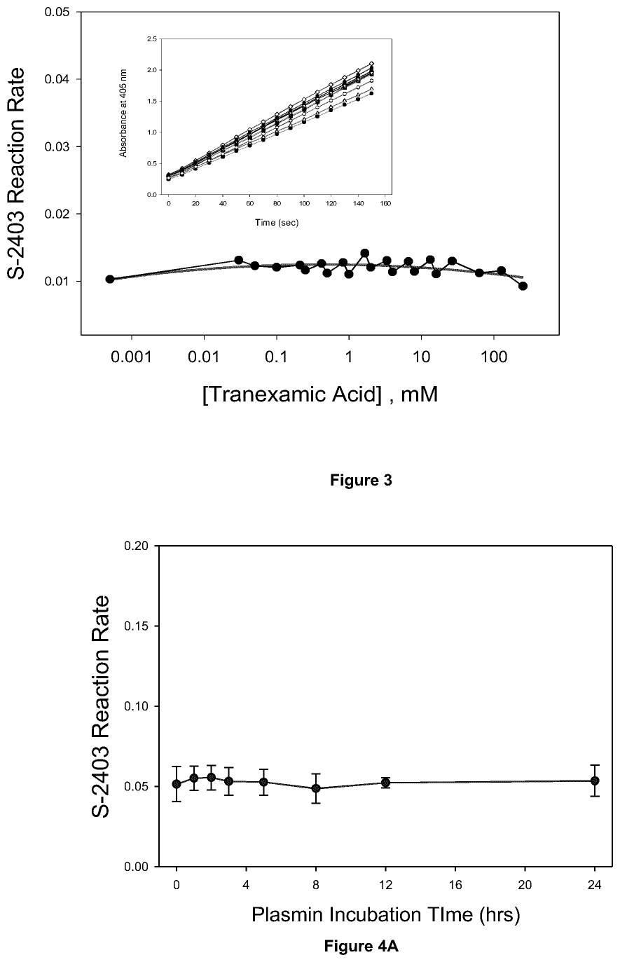

S-2403 is a commercially available, plasmin specific chromogenic substrate. The substrate was utilised to measure plasmin activity in the presence of TXA as illustrated in FIG. 3. The proteolytic activity of plasmin at a concentration of 1 mg/mL exhibited unaltered kinetics in the presence of varying TXA concentrations (0.001 mM to 100 mM). Accordingly, it was concluded that TXA could be formulated alongside plasmin without any detrimental effect on its proteolytic activity.

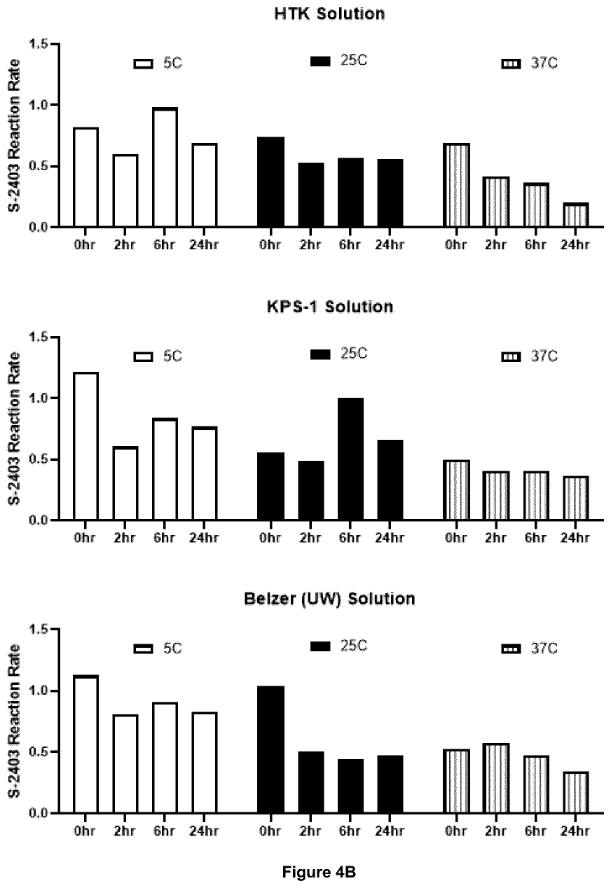

To assess the compatibility of plasmin as an additive in Cold Storage Solutions, the activity of plasmin at a concentration of 1 mg/mL was assessed at multiple time points whilst stored at 0° C. The results are plotted in FIG. 4A, from which it is clear that plasmin at a concentration of 1 mg/mL exhibited unaltered kinetics whilst stored at 0° C. over a 24-hour period.

Results in FIG. 4b make evident that plasmin formulated in tranexamic acid and diluted directly into a variety of commonly utilized organ preservation solutions maintain plasmin activity for at least 24 hours at temperatures commonly utilized in organ transplant preservation and reconditioning methods. Plasmin formulated at 10 mg/ml with 5 mM tranexamic acid was diluted 1:100 (0.1 mg/ml plasmin and 0.05 mM tranexamic acid final concentrations) directly into HTK, KPS-1, or Belzer University of Wisconsin (UW) organ preservation solutions with no other additives and were maintained at 5° C. (white bars), 25° C. (black bars), or 37° C. (striped bars) for a 24 hour period. The commercial S-2403 plasmin specific chromogenic substrate was used to assess activity at each of the indicated times.

Results in FIG. 4c clearly show that plasmin formulated in tranexamic acid or ε-aminocaproic acid and diluted directly into a variety of commonly utilized organ preservation solutions maintain plasmin activity for at least 1 month when stored at 5° C. Plasmin formulated at 10 mg/mL with 10 mM ε-aminocaproic acid (eACA), 1 mM tranexamic acid (TXA), 5 mM tranexamic acid (TXA), or 10 mM tranexamic acid (TXA) were diluted 1:100 (0.1 mg/mL plasmin and 0.1 mM eACA, 0.01 mM TXA, 0.05 mM TXA, or 0.1 mM TXA final concentrations) directly into HTK, KPS-1, or Belzer University of Wisconsin (UW) organ preservation solutions with no other additives and were maintained at 5° C. for 1 month. Significant plasmin activity is maintained when formulated with these excipients and diluted into organ preservation and reconditioning solutions. The commercial S-403 plasmin specific chromogenic substrate was used to assess activity at each of the indicated times.

### Example 2: Rat Liver Transplantation Studies

Rat liver recovery. Male Lewis rats (200-300 grams) were used as donors. General anaesthesia was induced using 5% isoflurane and maintained at 1-2% via nose cone during the procedure. The abdomen was opened using a cruciate incision. The left phrenic vein was dissected, ligated, and divided. The posterior caudate lobe was dissected away from the stomach and spleen. The common bile duct was dissected and cannulated using a 24G angiocath tied with 5-0 silk ties. The hepatic artery was dissected near the hilum and divided between ties. The portal vein was dissected and the two most proximal tributaries ligated and divided between ties. Heparin (250 units) was injected systemically via the inferior vena cava and allowed to circulate for 3 minutes. The portal vein was clamped for 30 minutes. Following the in-situ ischemic period, the portal vein was cannulated and secured with 5-0 silk ties. The liver was then flushed with 50 ml of ice-cold HTK solution (Custodiol®; no additives). During the flush, the inferior IVC was opened sharply with scissors to drain the blood effluent from the liver. Once the flush was completed, the liver was explanted by dissecting in a clockwise manner, dividing vessels and ligaments starting with the superior IVC, left and right coronary ligaments, posterior attachments to the spine (only in non-implant).

Cold storage cohort. Following liver explant, the liver was kept at room temperature (original cohort; in second cohort, this was done on ice) while vascular cuffs were inserted into the portal vein and infrahepatic vena cava. The cuffing process took 10-15 minutes. Following this, a 200 ml back table flush was performed using HTK with either albumin (control) or plasmin:tranexamic acid (1:50 molar ratio, 0.1 mg/mL plasmin). The liver was then stored on ice for 1 hour. Following the cold storage period, a final pre-implant flush consisting of 100 ml of HTK (no additives) was performed prior to implantation.

Machine perfusion cohort. Following liver explant, subnormothermic machine perfusion was initiated at room temperature. DEVOL solution perfusate was utilised, and its base consisted of Duosol 4555 and 4% human albumin. Additives include heparin, zosyn, dexamethasone, bicarbonate, and calcium gluconate. In the experimental arm, plasmin:tranexamic acid (1:50 molar ratio) was added to 200 ml of perfusate to yield a final concentration of 0.1 mg/mL plasmin. Following 1 hr of machine perfusion, vascular cuffs were inserted into the portal vein and infrahepatic vena cava at room temperature (original cohort; in second cohort, this was done on ice). A final pre-implant flush with 100 ml HTK (no additives) was performed prior to implantation.

Liver transplant procedure. The liver was transplanted in orthotopic fashion as previously described by Abraham et al. (Abraham N et al., Front Med (Lausanne). 2022; 9:804834. doi: 10.3389/fmed.2022.804834), the contents of which are incorporated herein by reference.

Study endpoints. Subject survival was recorded on post-operative day 1. Surviving subjects were sacrificed under general anaesthesia. A midline laparotomy was performed and the volume of ascites and haematocrit of ascites was recorded. Exsanguination was performed by blood collection from the vena cava, which was centrifuged and used to measure liver function tests. The liver graft and bile duct were biopsied and preserved in formalin for histologic examination.

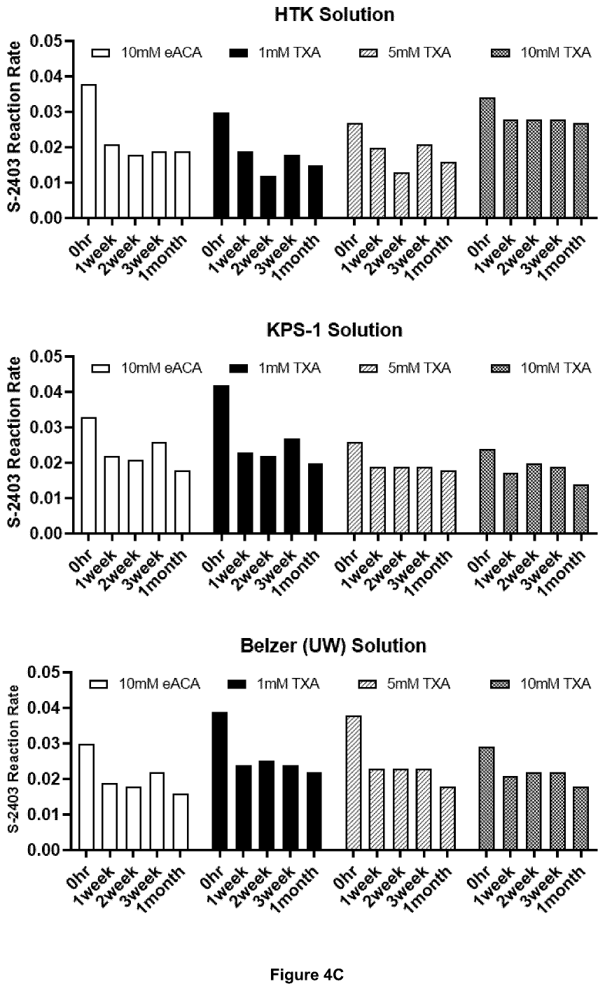

Results. After 1 h of cold storage in the presence of plasmin/tranexamic acid, a significant survival benefit at 24 hrs (80% vs 14.2% survival, P=0.0293) post-transplantation was observed, see FIG. 5. The low number of survivors in the control group prohibited meaningful comparison of biliary injury levels.

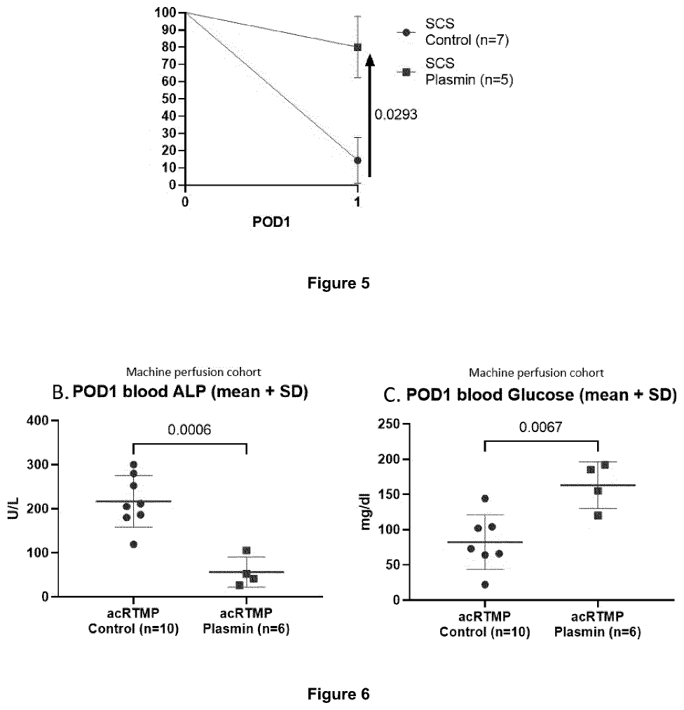

Liver function panel assessments in the machine perfusion cohort demonstrated signs of improved function after post-operative day 1 (POD1). After 1 h of machine perfusion, there was a significant decrease in 24 h serum alkaline phosphatase with plasmin/tranexamic acid administration (mean 216.6 vs 56 U/L, P=0.0006). In addition, glucose homeostasis was improved in recipients of plasmin-treated grafts at 24 h (mean 163 vs. 82.3 mg/dl, P=0.0067). These results are plotted in FIG. 6.

No overt bleeding complications were observed post-transplant in either modes of organ preservation.

### Sequences

The sequences referred to in the preceding text are outlined below in fasta format. In the event of a discrepancy between the sequence listed in this text and the corresponding sequence in the accompanying sequence listing, the sequence listed in this text shall be the prevailing sequence for the purposes of correcting an error.

Human Plasminogen Protein Sequence
SEQ ID NO: 1
EPLDDYVNTQGASLFSVTKKQLGAGSIEECAAKCEEDEEFTCRAFQ
YHSKEQQCVIMAENRKSSIIIRMRDVVLFEKKVYLSECKTGNGKN
YRGTMSKTKNGITCQKWSSTSPHRPRESPATHPSEGLEENYCRNP
DNDPQGPWCYTTDPEKRYDYCDILECEEECMHCSGENYDGKISKT
MSGLECQAWDSQSPHAHGYIPSKFPNKNLKKNYCRNPDRELRPWC
FTTDPNKRWELCDIPRCTTPPPSSGPTYQCLKGTGENYRGNVAVT
VSGHTCQHWSAQTPHTHNRTPENFPCKNLDENYCRNPDGKRAPWC
HTTNSQVRWEYCKIPSCDSSPVSTEQLAPTAPPELTPVVQDCYHG
DGQSYRGTSSTTTTGKKCQSWSSMTPHRHQKTPENYPNAGLTMNY
CRNPDADKGPWCFTTDPSVRWEYCNLKKCSGTEASVVAPPPVVLL
PDVETPSEEDCMFGNGKGYRGKRATTVTGTPCQDWAAQEPHRHSI
FTPETNPRAGLEKNYCRNPDGDVGGPWCYTTNPRKLYDYCDVPQC
AAPSEDCGKPQVEPKKCPGRVVGGCVAHPHSWPWQVSLRTRFGMH
FCGGTLISPEWVLTAAHCLEKSPRPSSYKVILGAHQEVNLEPHVQ
EIEVSRLFLEPTRKDIALLKLSSPAVITDKVIPACLPSPNYVVAD
RTECFITGWGETQGTFGAGLLKEAQLPVIENKVCNRYEFLNGRVQ
STELCAGHLAGGTDSCQGDSGGPLVCFEKDKYILQGVTSWGLGCA
RPNKPGVYVRVSRFVTWIEGVMRNN

What is claimed is:

1. A stable composition for organ reconditioning comprising:
plasmin,
a lysine mimetic, and
a pharmaceutically acceptable organ preservation solution having a pH of about 6 to about 8,
wherein the molar ratio of plasmin:lysine mimetic is from about 1:1 to about 1:10,000.

2. The composition according to claim 1, wherein plasmin is selected from the group consisting of plasmin, a functional mutant thereof, a functional fragment thereof or combinations thereof.

3. The composition according to claim 2, wherein the functional fragment of plasmin is selected from the group consisting of midi-plasmin, mini-plasmin, micro-plasmin and delta-plasmin.

4. The composition according to claim 2, wherein the plasmin is selected from the group consisting of Glu-plasmin and Lys-plasmin,

5. The composition according to claim 1, wherein the lysine mimetic is chosen from the group consisting of tranexamic acid, ε-aminocaproic acid, L-lysine, L-arginine, L-ornithine, γ-aminobutyric acid, 5-aminovaleric acid, 7-aminoheptanoic acid, glycylglycine, triglycine, N-α-acetyl-L-arginine, betaine, sulfanilic acid, pharmaceutically acceptable salts thereof, and combinations thereof, or wherein the lysine mimetic is a compound of the general formula (i) or a pharmaceutically acceptable salt thereof: 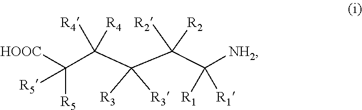
wherein
each of R₁-R₅, and each R_{1′}-R_{5′} is the same or different and is independently selected from the group consisting of hydrogen, halogen, C₁-C₅ alkyl, C₁-C₅ haloalkyl, OH, C₁-C₅ alkoxy, C₁-C₅ haloalkoxy, SH, C₁-C₅ alkylthio, C₁-C₅ haloalkylthio, C₁-C₆ alkylsulfinyl, C₁-C₆ haloalkylsulfinyl, C₁-C₅ alkylsulfonyl, C₁-C₅ haloalkylsulfonyl, C₁-C₆ alkylsulfonamido, C₁-C₆ haloalkylsulfonamido, C₁-C₆ bis(alkyl)sulfonamido, C₁-C₅ bis(haloalkyl)sulfonamido, NH₂, NH(C₁-C₆ alkyl), N(C₁-C₆ alkyl)₂, NH(C₁-C₅ haloalkyl), N(C₁-C₅ haloalkyl), N(C₁-C₅ alkyl)(C₁-C₅ haloalkyl), C(O)NH(C₁-C₆ alkyl), C(O)N(C₁-C₆ alkyl)₂, C(O)NH(C₁-C₆ haloalkyl), C(O)N(C₁-C₆ haloalkyl)₂, C(O)N(C₁-C₆ alkyl)(C₁-C₆ haloalkyl), C(O)H, C(O)C₁-C₆ alkyl, C(O)C₁-C₆ haloalkyl, C(O)O(C₁-C₆ alkyl), C(O)O(C₁-C₆ haloalkyl), OC(O)C₁-C₆ haloalkyl, OC(O)C₁-C₆ alkyl, SF5, SCN, cyano, and nitro, or
wherein the lysine mimetic is a compound of the general formula (ii) or a pharmaceutically acceptable salt thereof: 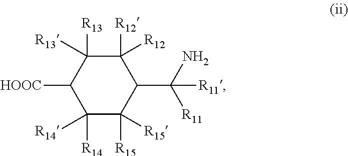
wherein
each of R₁₁-R₁₅, and each R_{11′}-R_{15′} is the same or different and is independently selected from the group consisting of hydrogen, halogen, C₁-C₅ alkyl, C₁-C₅ haloalkyl, OH, C₁-C₅ alkoxy, C₁-C₅ haloalkoxy, SH, C₁-C₅ alkylthio, C₁-C₅ haloalkylthio, C₁-C₆ alkylsulfinyl, C₁-C₆ haloalkylsulfinyl, C₁-C₅ alkylsulfonyl, C₁-C₅ haloalkylsulfonyl, C₁-C₆ alkylsulfonamido, C₁-C₆ haloalkylsulfonamido, C₁-C₆ bis(alkyl)sulfonamido, C₁-C₅ bis(haloalkyl)sulfonamido, NH₂, NH(C₁-C₆ alkyl), N(C₁-C₆ alkyl)₂, NH(C₁-C₅ haloalkyl), N(C₁-C₅ haloalkyl)₂, N(C₁-C₅ alkyl)(C₁-C₅ haloalkyl), C(O)NH(C₁-C₆ alkyl), C(O)N(C₁-C₆ alkyl)₂, C(O)NH(C₁-C₆ haloalkyl), C(O)N(C₁-C₆ haloalkyl)₂, C(O)N(C₁-C₆ alkyl)(C₁-C₆ haloalkyl), C(O)H, C(O)C₁-C₆ alkyl, C(O)C₁-C₆ haloalkyl, C(O)O(C₁-C₆ alkyl), C(O)O(C₁-C₆ haloalkyl), OC(O)C₁-C₆ haloalkyl, OC(O)C₁-C₆ alkyl, SF5, SCN, cyano, and nitro.

6. (canceled)

7. (canceled)

8. (canceled)

9. The composition according to claim 1, wherein plasmin is present in a concentration of about 0.01 mg/mL to about 50 mg/mL.

10. The composition according to claim 1, wherein the lysine mimetic is present in a concentration of about 0.1 μM to about 0.6 M.

11. The composition according to claim 1, wherein the pharmaceutically acceptable organ perfusate has an osmolality of between about 200 to about 400 mOsm/Kg.

12. (canceled)

13. (canceled)

14. The composition according to claim 1, wherein the pharmaceutically acceptable organ preservation solution comprises an additive selected from the group consisting of albumin, a dextran compound, a physiologically acceptable salt, and combinations thereof.

15. The composition according to claim 14, wherein the concentration of albumin is from about 1 mg/mL to about 100 mg/mL, from about 5 mg/mL to about 85 mg/mL, from about 10 mg/mL to about 70 mg/mL, from about 20 mg/mL to about 60 mg/mL, from about 5 mg/mL to about 30 mg/mL, from about 60 mg/mL to about 90 mg/mL, from about 50 mg/mL to about 100 mg/mL, from about 55 mg/mL to about 85 mg/mL, from about 60 mg/mL to about 80 mg/mL, from about 65 mg/mL to about 85 mg/mL, from about 70 mg/mL to about 80 mg/mL, about 50 mg/mL, about 60 mg/mL, about 65 mg/mL, about 70 mg/mL, about 75 mg/mL, about 80 mg/mL, about 85 mg/mL, about 90 mg/mL, or about 100 mg/mL.

16. (canceled)

17. (canceled)

18. The composition according to claim 14, wherein the concentration of dextran compound is from about 1 mg/mL to about 55 mg/mL, from about 2 mg/mL to about 25 mg/mL, from about 2 mg/mL to about 20 mg/mL, from about 2 mg/mL to about 10 mg/mL, about 2 mg/mL, about 5 mg/mL, about 10 mg/mL, about 20 mg/mL, or about 25 mg/mL.

19. (canceled)

20. (canceled)

21. The composition according to claim 14, wherein the physiologically acceptable salt is selected from the group consisting of sodium chloride, potassium chloride, calcium chloride, magnesium chloride, sodium dihydrogen phosphate, sodium bicarbonate, sodium hydroxide, and combinations thereof.

22. (canceled)

23. (canceled)

24. (canceled)

25. The composition according to claim 1, wherein the pharmaceutically acceptable organ preservation solution comprises at least one additive selected from the group consisting of a physiologically acceptable salt, a buffer, a colloidal carbohydrate, an antioxidant, and combinations thereof.

26. The composition according to claim 25, wherein the physiologically acceptable salt comprises an ion selected from the group consisting of a sodium ion, potassium ion, calcium ion, magnesium ion, hydrogen carbonate ion, bicarbonate ion, chloride ion, and combinations thereof, wherein the buffer comprises a phosphate-based butter or is an amino acid selected from the group consisting of histidine, tryptophan, N-acetylhistidine, glycine, alanine, arginine, aspartate, glutamic acid, and combinations thereof,
wherein the colloidal carbohydrate may be selected from the group consisting of a dextran compound, mannitol, and combinations thereof, and/or
wherein the antioxidant may be selected from the group consisting of α-ketoglutarate, glutathione, and combinations thereof.

27. (canceled)

28. (canceled)

29. (canceled)

30. (canceled)

31. The composition according to claim 1, wherein the pharmaceutically acceptable organ preservation solution is the STEEN solution or a cold storage solution selected from the group consisting of the Euro Collins (EC) solution, the HTK/Custodiol solution, the Celsior solution, the Perfadex solution, the KPS-1, Belzer University of Wisconsin (UW) the EP-TU solution, the ET-Kyoto solution, and combinations thereof.

32. (canceled)

33. (canceled)

34. (canceled)

35. (canceled)

36. A method of preserving or reconditioning an organ prior to transplantation, the method comprising contacting the organ with the composition of claim 1.

37. The method according to claim 36, wherein the organ is perfused with the composition of claim 1.

38. (canceled)

39. Method according to claim 36, where said composition is contacted with the organ by washing, immersion, perfusion or a combination thereof.

40. (canceled)

41. (canceled)

42. (canceled)

43. The method according to claim 36, wherein the organ is contacted with or perfused with the composition of the present invention at a temperature selected from the group consisting of 20-37° C., 0-10° C., and about 0° C.

44. The method according to claim 36, wherein the organ is a liver, a kidney, a lung or a heart.


SEQUENCE LISTING (1 sequence)

SEQ ID NO: 1 - protein, 791 aa, Homo sapiens
EPLDDYVNTQGASLFSVTKKQLGAGSIEECAAKCEEDEEFTCRAFQYHSKEQQCVIMAENRKSSIIIRMRDVVLFEKKVYLSECKTGNGKNYRGTMSKTKNGITCQKWSSTSPHRPRFSPATHPSEGLEENYCRNPDNDPQGPWCYTTDPEKRYDYCDILECEEECMHCSGENYDGKISKTMSGLECQAWDSQSPHAHGYIPSKFPNKNLKKNYCRNPDRELRPWCFTTDPNKRWELCDIPRCTTPPPSSGPTYQCLKGTGENYRGNVAVTVSGHTCQHWSAQTPHTHNRTPENFPCKNLDENYCRNPDGKRAPWCHTTNSQVRWEYCKIPSCDSSPVSTEQLAPTAPPELTPVVQDCYHGDGQSYRGTSSTTTTGKKCQSWSSMTPHRHQKTPENYPNAGLTMNYCRNPDADKGPWCFTTDPSVRWEYCNLKKCSGTEASVVAPPPVVLLPDVETPSEEDCMFGNGKGYRGKRATTVTGTPCQDWAAQEPHRHSIFTPETNPRAGLEKNYCRNPDGDVGGPWCYTTNPRKLYDYCDVPQCAAPSFDCGKPQVEPKKCPGRVVGGCVAHPHSWPWQVSLRTRFGMHFCGGTLISPEWVLTAAHCLEKSPRPSSYKVILGAHQEVNLEPHVQEIEVSRLFLEPTRKDIALLKLSSPAVITDKVIPACLPSPNYVVADRTECFITGWGETQGTFGAGLLKEAQLPVIENKVCNRYEFLNGRVQSTELCAGHLAGGTDSCQGDSGGPLVCFEKDKYILQGVTSWGLGCARPNKPGVYVRVSRFVTWIEGVMRNN